(19) United States
(12) Patent Application Publication
(10) Pub. No.: US 2011/0291821 A1
(43) Pub. Date: Dec. 1, 2011

(54) HAPTIC DEVICE

(75) Inventor: Il Kwon Chung, Gyunggi-do (KR)

(73) Assignee: SAMSUNG ELECTRO-MECHANICS CO., LTD., Gyunggi-do (KR)

(21) Appl. No.: 12/870,621

(22) Filed: Aug. 27, 2010

(30) Foreign Application Priority Data
May 31, 2010 (KR) 10-2010-0051167

(51) Int. Cl. G08B 6/00

(52) U.S. Cl. 340/407.2

(57) ABSTRACT

Disclosed herein is a haptic device 100. The haptic device 100 includes: a substrate 20 receiving a touch of an input unit 10; a piezoelectric vibrator 30 provided on the substrate 20 and applying vibration; a piezoelectric vibration sensor 40 provided on the substrate 20 and sensing the variation in the vibration by the pressure of the touch; and a controller measuring the pressure of the touch through the variation in the vibration sensed by the piezoelectric vibration sensor 40, and has an advantage of implementing various interfaces varying depending on the magnitude of pressure by sensing the variation in vibration by means of the piezoelectric vibration sensor 40 when the input unit 10 touches the substrate 20 and measuring the pressure of the touch in the controller.

### CROSS REFERENCE TO RELATED APPLICATION

This application claims the benefit of Korean Patent Application No. 10-2010-0051167, filed on May 31, 2010, entitled “Haptic Device”, which is hereby incorporated by reference in its entirety into this application.

### BACKGROUND OF THE INVENTION

1. Technical Field

The present invention relates to a haptic device.

2. Description of the Related Art

With the development of computers using a digital technology, auxiliary devices for the computers are also being developed. Personal computers, portable transmitting apparatuses, and other personal information processing apparatuses process texts and graphics by using various input devices such as a keyboard, a mouse, and the like.

However, with the rapid progress of information society, computers are gradually used for various purposes, as a result, it is difficult to efficiently drive products by using only the keyboard and the mouse, which serve as the input device. The necessity of an apparatus which is simple and easily prevents error in control, and enables anyone to easily input information has increased and in order to meet the necessity, a touch panel has been developed as an input device capable of inputting information such as texts, graphics, etc.

However, the touch panel in the prior art can just measure an X coordinate and a Y coordinate of a touch point touched by an input unit such as a finger, i.e., only a 2D coordinate, but cannot measure a Z coordinate which is a pressure value of the input unit, as a result, various interfaces changed depending on the magnitude of the pressure value cannot be implemented.

Meanwhile, in recent years, research of a touch panel providing haptic feedback, which is one kind of tactile feedback, has actively progressed in order to improve a signal transmission effect of the touch panel to a user. In general, the haptic feedback uses an eccentric rotating mass (ERM) motor or an electromagnetic motor that generates vibration when rotation is unbalanced while rotating by directionally configuring a weight center of a rotor to be eccentric.

However, the haptic feedback using ERM motor or electromagnetic motor in the prior art just applies vibration to the touch panel and has a limit in implementing a realistic touch sense which can be transferred by stimulating a user's skin. In particular, the haptic feedback in the prior art has a limit in implementing a click sense giving vibration or resistance when a button is pressed, a drag sense giving a feel if an object moves along at the time of pushing and moving an object, roughness felt at the time of touching the surface, a texture sense giving a surface texture such as a fine shape, etc., and, as a result, user operability is deteriorated.

### SUMMARY OF THE INVENTION

The present invention has been made in an effort to provide a haptic device capable of sensing the pressure of a touch by sensing the variation in vibration while touching and improving user operability by implementing a touch sense such as a drag sense or a texture sense.

A haptic device according to a preferred embodiment of the present invention includes: a substrate receiving a touch of an input unit; a piezoelectric vibrator provided on the substrate and applying vibration; a piezoelectric vibration sensor provided on the substrate and sensing the variation in the vibration by the pressure of the touch; and a controller measuring the pressure of the touch through the variation in the vibration sensed by the piezoelectric vibration sensor.

Herein, the piezoelectric vibration sensor measures a decrease amount in a resonant frequency of the piezoelectric vibrator to sense the variation in the vibration by the pressure of the touch.

Further, the piezoelectric vibration sensor measures a decrease amount of displacement in the vibration of the substrate to sense the variation in the vibration by the pressure of the touch.

When the vibration applied by the piezoelectric vibrator is uniform, the piezoelectric vibration sensor senses the variation in the vibration by the pressure of the touch.

The input unit moves on the substrate at a predetermined velocity and the piezoelectric vibrator varies the maximum vibration velocity to be higher than the predetermined velocity at the time of applying vibration to the substrate and controls the friction force between the input unit and the substrate.

The substrate is a touch panel and a display panel corresponding to the substrate is provided on one side of the substrate.

The substrate is a panel for protecting the touch panel and the touch panel corresponding to the substrate is provided on one side of the substrate.

The piezoelectric vibrator is provided on one side of the substrate and the piezoelectric vibration sensor is provided on the other side of the substrate.

### BRIEF DESCRIPTION OF THE DRAWINGS

FIG. 1 is a perspective view of a haptic device according to a first preferred embodiment of the present invention;

FIGS. 2 to 4 are diagrams showing the friction force between an input unit and a substrate;

FIGS. 5 and 6 are diagrams showing the relationship between the maximum vibration velocity and the friction force;

FIG. 7 is a diagram showing the variation in vibration when an input unit touches a substrate; and

FIG. 8 is a perspective view of a haptic device according to a second preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

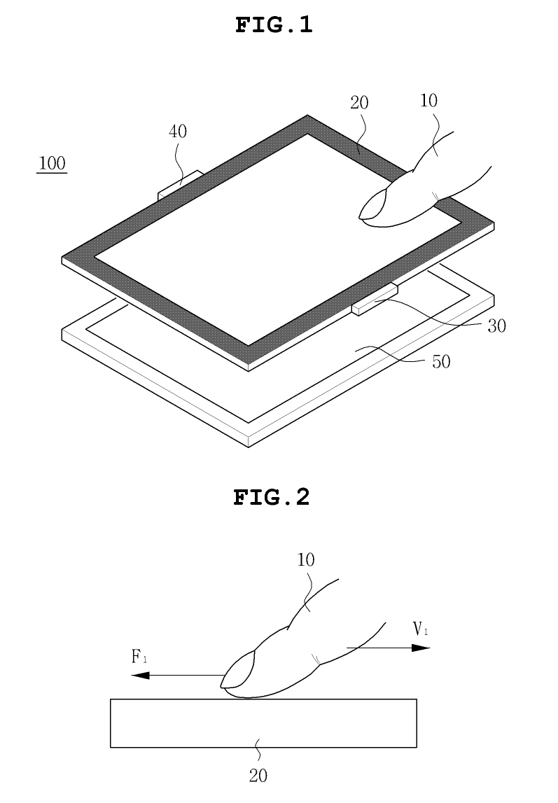

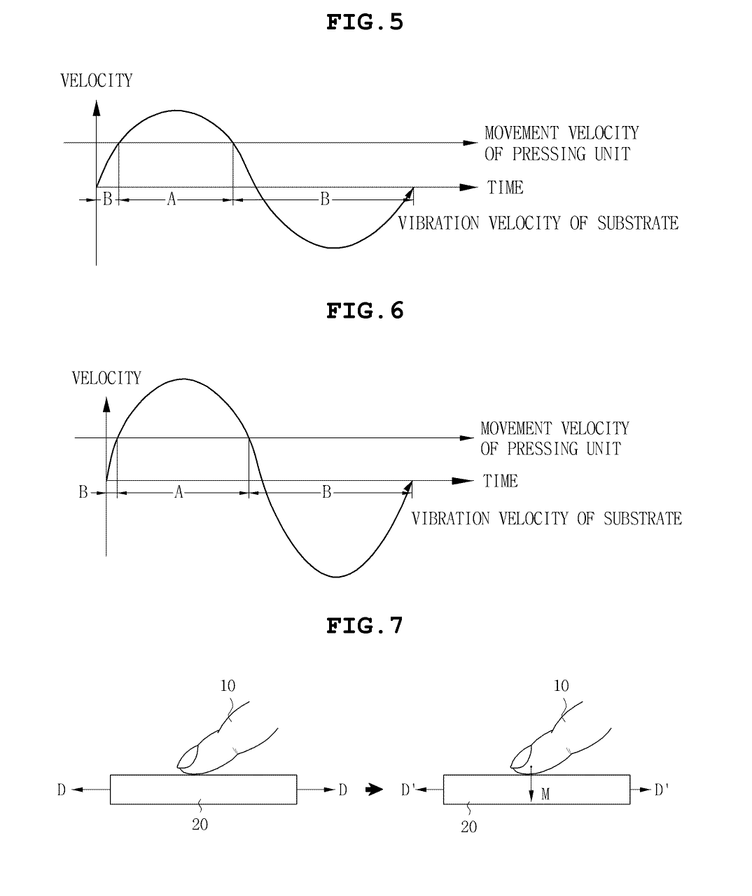

FIG. 1 is a perspective view of a haptic device according to a first preferred embodiment of the present invention, FIGS. 2 to 4 are diagrams showing the friction force between an input unit and a substrate, FIGS. 5 and 6 are diagrams showing the relationship between the maximum vibration velocity and the friction force, and FIG. 7 is a diagram showing the variation in vibration when an input unit touches a substrate.

As shown in FIG. 1, the haptic device 100 according to the embodiment of the present invention includes a substrate 20 receiving a touch of an input unit 10, a piezoelectric vibrator 30 provided on the substrate 20 to apply vibration, a piezoelectric vibration sensor 40 provided on the substrate 20 to sense the variation of vibration by the pressure of the touch, and a controller measuring the pressure of the touch through the variation in the vibration sensed by the piezoelectric vibration sensor 40.

The substrate 20 serves to receive the touch of the input unit 10 such as a finger, etc., and the substrate 20 is a touch panel in the haptic device 100 according to the embodiment. Herein, the touch panel includes all types that can measure an X coordinate and a Y coordinate of a touch point, such as a resistive type, a capacitive type, an electromagnetic type, a surface acoustic wave (SAW) type, and an infrared type.

The piezoelectric vibrator 30 serves to allow a user to feel a touch sense by vibrating the substrate 20 and serves to provide a condition under which the piezoelectric vibration sensor 40 can sense variation in the vibration by vibrating the substrate 20. Herein, the piezoelectric vibrator 30 generates vibration on the substrate 20 by using an inverse piezoelectric effect generated in which stress is generated at the time of applying voltage.

Hereinafter, a method for controlling the friction force between the input unit 10 and the substrate 20 by using the vibration generated by the piezoelectric vibrator 30 will be described.

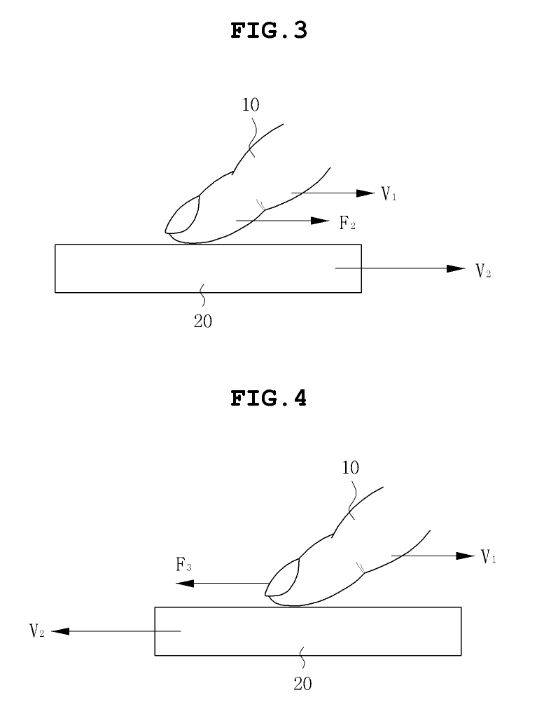

As shown in FIG. 2, when the input unit 10 moves at predetermined velocity V₁ while the substrate 20 is fixed, the friction force F₁ is generated in an inverse direction to a movement direction of the input unit 10. However, as shown in FIG. 3, when the movement direction of the input unit 10 is the same as a vibration direction of the substrate 20 and the vibration velocity V₂ of the substrate 20 is higher than the movement velocity V₁ of the input unit 10, friction force F₂ is generated in the same direction as the movement direction of the input unit 10. Of course, since the substrate 20 vibrates, the substrate 20 should be restored to an original position. Therefore, as shown in FIG. 4, the movement direction of the input unit 10 is essentially opposite to the vibration direction of the substrate 20, but in this case, friction force F₃ is equal to the friction force F₁ when the substrate 20 is fixed (the reason is that the friction force is not influenced by the velocity and is in proportion to a movement friction coefficient and the normal force of the input unit 10). As a result, when the vibration velocity of the substrate 20 is higher than the movement velocity of the input unit 10, friction force felt by the user for a predetermined time due to the friction force F₂ is smaller than the friction force F₁ when the substrate 20 is fixed.

Since the friction force that is felt by the user for a predetermined time when the substrate 20 vibrates is influenced by F₂ and F₃, the friction force can be controlled by adjusting a ratio between F₂ and F₃. As shown in FIGS. 5 and 6, when the vibration velocity of the substrate 20 is higher than the movement velocity of the input unit 10 (A), the friction force F₂ is applied in the same direction as the movement direction of the input unit 10 and when the vibration velocity of the substrate 20 is lower than the movement velocity of the input unit 10 (B), the friction force F₃ is applied in a reverse direction to the movement direction of the input unit 10. Further, when the maximum vibration velocity of the substrate 20 is increased (FIG. 5→FIG. 6), a period (A) when the friction force F₂ is applied in the same direction as the movement direction of the input unit 10 is lengthened and a period (B) when the friction force F₃ is applied to in a reverse direction to the movement direction of the input unit 10 is shortened, as a result, the friction force felt by the user for a predetermined time is reduced. That is, when the maximum vibration velocity is increased, the friction force felt by the user for a predetermined time is decreased and when the maximum vibration velocity is decreased, the friction force felt by the user for a predetermined time is increased, as a result, the friction force between the substrate 20 and the input unit 10 can be controlled by changing the maximum vibration velocity. As described above, the haptic device 100 according to the embodiment implements the touch sense such as a drag sense or a texture sense by controlling the friction force so as to improve user operability. However, since the user should not feel the variation of the maximum vibration velocity but the variation of the friction force, the piezoelectric vibrator 30 preferably vibrates the substrate 20 at a high frequency at which the user cannot feel as the vibration.

Meanwhile, the piezoelectric vibrator 30 is preferably provided on one side of the substrate 20 in order to effectively transfer the vibration to the substrate 20 (see FIG. 1).

The piezoelectric vibration sensor 40 serves to sense the variation in the vibration when the input unit 10 touches the substrate 20. Herein, when the piezoelectric vibration sensor 40 applies the pressure, the piezoelectric vibration sensor 40 senses the variation in the vibration by using a piezoelectric effect in which positive charges and negative charges, which are in proportion to external force, are generated.

First, since the piezoelectric vibration sensor 40 senses the variation in the vibration, the piezoelectric vibrator 30 should vibrate the substrate 20. However, as described above, the piezoelectric vibrator 30 vibrates the substrate 20 while varying the maximum vibration velocity in order to control the friction between the substrate 20 and the input unit 10, the piezoelectric vibration sensor 40 is difficult to accurately sense the variation in the vibration. Accordingly, the piezoelectric vibration sensor 40 preferably senses the variation in the vibration by the pressure of the touch when the vibration applied by the piezoelectric vibrator 30 is uniform.

Hereinafter, referring to FIG. 7, a method for sensing the variation in the vibration when the input unit 10 touches the substrate 20 will be described.

When the input unit 10 touches the substrate 20 while the piezoelectric vibrator 30 vibrates the substrate 20, a resonant frequency of the piezoelectric vibrator 30 varies by the pressure of the touch. For example, the resonant frequency f₀ of the piezoelectric vibrator 30 before the input unit 10 touches the substrate 20 is (1/(2π))×√(k/m) (k: spring constant, m: mass), but when the input unit 10 touches the substrate 20, the resonant frequency of the piezoelectric vibrator 30 decreases to f₀′=f₀×√(m+M)) (M: mass added by the touch). That is, as the pressure of the touch increases, the resonant frequency of the piezoelectric vibrator 30 decreases. Therefore, the piezoelectric vibration sensor 40 can sense the variation in the vibration by measuring an amount (Δf₀=f₀−f₀′) of the resonant frequency of the piezoelectric vibrator 30 which decreases.

Further, when the input unit 10 touches the substrate 20 while the piezoelectric vibrator 30 vibrates the substrate 20, the displacement of the substrate 20 decreases in comparison before the touch by the pressure of the touch (D→D′). That is, as the pressure of the touch increases, the displacement in the vibration in the substrate 20 decreases. Therefore, the piezoelectric vibration sensor 40 can sense the variation in the vibration by measuring a reduction amount (ΔD=D−D′) of the displacement in the vibration of the substrate 20.

A method for measuring the above-mentioned decrease amount (Δfₒ) of the resonant frequency or a method for measuring a decrease amount (AD) of the displacement is selective and the piezoelectric vibration sensor 40 may use any one of the above-mentioned methods and may sense the variation in the vibration by using both methods.

Meanwhile, the piezoelectric vibration sensor 40 is preferably provided on the other side of the substrate 20 which is opposite to the side on which the piezoelectric vibrator 30 is provided in order to accurately measure the variation in the vibration applied by the piezoelectric vibrator 30 (see FIG. 1).

The controller serves to measure the pressure of the touch and measure the pressure of the touch on the basis of the variation in the vibration sensed by the piezoelectric vibration sensor 40. That is, as described above, when the piezoelectric vibration sensor 40 measures the decrease amount (Δf₀) of the resonant frequency to sense the variation in the vibration, the controller computes the pressure of the touch on the basis of the decrease amount (Δf₀) of the resonant frequency. Further, when the piezoelectric vibration sensor 40 measures the decrease amount (ΔD) of the displacement to sense the variation in the vibration, the controller measures the decrease amount (ΔD) of the displacement to compute the pressure of the touch.

As described above, since the haptic device 100 according to the embodiment measures the pressure of the touch by using the vibration of the piezoelectric vibrator 30, the haptic device 100 is advantageous in that the accurate pressure of the touch can be measured only by the piezoelectric vibration sensor 40 and the controller having a simple structure.

Meanwhile, in the embodiment, since the substrate 20 is the touch panel, a display panel 50 corresponding to the substrate 20 is preferably provided on one side of the substrate 20. Herein, the display panel 50 serves to output an image and includes a liquid crystal display device (LCD), a plasma display panel (PDP), electroluminescence (EL), or a cathode ray tube (CRT). Further, when the display panel 50 is attached onto one side of the substrate 20, the display panel 50 is preferably made of a transparent material so as to prevent the user from being interfered in recognizing the image outputted by the display panel 50, for example, an optical clear adhesive (OCA).

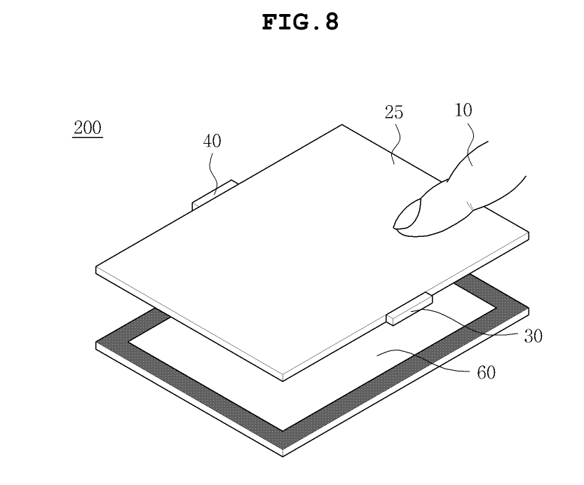

FIG. 8 is a perspective view of a haptic device according to a second preferred embodiment of the present invention.

As shown in FIG. 8, a haptic device 200 according to the embodiment is largely different from the haptic device 100 according to the first embodiment in terms of a substrate 25. Therefore, the haptic device 200 according to the embodiment is described primarily on the basis of the substrate 25 and any duplicate description is omitted.

In the first embodiment, the substrate 20 is the touch panel, while in the embodiment, the substrate 25 is a panel for protecting the touch panel. Therefore, the piezoelectric vibrator 30 and the piezoelectric vibration sensor 40 are provided on one side and the other side of the panel for protecting the touch panel, respectively. That is, the piezoelectric vibrator 30 and the piezoelectric vibration sensor 40 may be provided directly on the touch panel as described in the first embodiment, but the piezoelectric vibrator 30 and the piezoelectric vibration sensor 40 may be provided on the panel for protecting the touch panel as described in the embodiment. Meanwhile, the panel for protecting the touch panel may be made of polyethylene terephthalate (PET), polycarbonate (PC), polymethyl methacrylate (PMMA), polyethylene naphthalate (PEN), polyether sulfone (PES), cyclic olefin polymer (COC), a triacetylcellulose (TAC) film, a polyvinyl alcohol (PVA) film, a polyimide (PI) film, polystyrene (PS), biaxially oriented PS (BOPS; containing K resin), glass or tempered glass, and the like, but is not limited thereto and in addition, the panel for protecting the touch panel may be made of all materials which can protect a touch panel 60 to be described below with predetermined strength or more and prevent the user from being interfered in recognizing the image.

Further, in the embodiment, since the substrate 25 is the panel for protecting the touch panel, the touch panel 60 corresponding to the substrate 25 is preferably provided on one side of the substrate 25. Herein, the touch panel 60 includes all types that can measure an X coordinate and a Y coordinate of a touch point, such as a resistive type, a capacitive type, an electro-magnetic type, a surface acoustic wave (SAW) type, and an infrared type. Meanwhile, the panel for protecting the touch panel and the touch panel 60 preferably adhere to each other by using an optical clear adhesive (OCA) or a double adhesive tape (DAT).

According to the present invention, it is possible to implement various interfaces varying depending on the magnitude of pressure by sensing the variation in vibration by means of a piezoelectric vibration sensor when an input unit such as a finger, etc., touches a substrate (touch panel) and measuring the pressure of a touch in a controller.

Further, according to the present invention, the maximum vibration velocity higher than the velocity of the input unit is changed by adopting a piezoelectric vibrator to vibrate the substrate (touch panel), as a result, it is possible to improve a user's touch sense by controlling the friction force between the input unit and the substrate.

Although the embodiments of the present invention has been disclosed for illustrative purposes, it will be appreciated that a haptic device according to the present invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A haptic device, comprising:
a substrate receiving a touch of an input unit;
a piezoelectric vibrator provided on the substrate and applying vibration;
a piezoelectric vibration sensor provided on the substrate and sensing the variation in the vibration due to the pressure of the touch; and
a controller measuring the pressure of the touch through the variation in the vibration sensed by the piezoelectric vibration sensor.

2. The haptic device as set forth in claim 1, wherein the piezoelectric vibration sensor measures a decrease amount of a resonant frequency of the piezoelectric vibrator to sense the variation in the vibration due to the pressure of the touch.

3. The haptic device as set forth in claim 1, wherein the piezoelectric vibration sensor measures a decrease amount of the displacement in the vibration of the substrate to sense the variation in the vibration due to the pressure of the touch.

4. The haptic device as set forth in claim 1, wherein when the vibration applied by the piezoelectric vibrator is uniform, the piezoelectric vibration sensor senses the variation in the vibration due to the pressure of the touch.

5. The haptic device as set forth in claim 1, wherein the input unit moves on the substrate at predetermined velocity and the piezoelectric vibrator varies the maximum vibration velocity higher than the predetermined velocity at the time of applying the vibration to the substrate and controls the friction force between the input unit and the substrate.

6. The haptic device as set forth in claim 1, wherein the substrate is a touch panel and a display panel corresponding to the substrate is provided on one side of the substrate.

7. The haptic device as set forth in claim 1, wherein the substrate is a panel for protecting the touch panel and the touch panel corresponding to the substrate is provided on one side of the substrate.

8. The haptic device as set forth in claim 1, wherein the piezoelectric vibrator is provided on one side of the substrate and the piezoelectric vibration sensor is provided on the other side of the substrate.
